(19) United States
(12) Patent Application Publication
(10) Pub. No.: US 2012/0079541 A1
(43) Pub. Date: Mar. 29, 2012

(54) One-Actuation Control of Synchronization of a Television System Terminal and a Mobile Device Display

(76) Inventor: Yang Pan, Singapore (SG)

(21) Appl. No.: 12/890,660

(22) Filed: Sep. 25, 2010

(51) Int. Cl. H04N 7/16

(52) U.S. Cl. 725/62

(57) ABSTRACT

A method for controlling of synchronization of a digital television terminal and a display of a mobile device is disclosed. In accordance with one embodiment, a dedicated input structure of the mobile device is used. When a video program is streamed by the mobile device, a single actuation by the user on the input structure triggers the terminal of the television to stream the same program in a synchronized manner. Similarly, when a video program is streamed by the television, a single actuation from the user leads to the mobile device to stream the same program in a synchronized manner.

### CROSS-REFERENCE TO RELATED APPLICATIONS

Not applicable.

### BACKGROUND

1. Field of Invention

This invention relates generally to media delivery system. More specifically, the invention relates to system and method for delivering media assets using a digital television system and a mobile computing and communication device.

2. Description of Prior Art

A digital television system is an electronic apparatus for a user to receive a television program. The program may be delivered by a content distributor to the digital television system through a communication network. The system provides a means for the user to select a preferred program from a large data base of the media assets.

Mobile computing and communication devices have gained significant popularity in recent years. Users are using the mobile device such as, for example, iPhone and iPad from Apple Inc, Cupertino, Calif., to access the Internet services. It has become popular for a user to receive a digital television program using the mobile devices. Therefore the user may view a program when he is moving around.

It becomes desirable that the user can switch easily between the devices by which the program is being broadcasted.

### SUMMARY OF THE INVENTION

It is an object of the present invention to propose a method for synchronizing of streaming a video program by a digital television system and a mobile computing and communication device.

It is another object of the present invention to propose a method of controlling the synchronization based on a “one-actuation” operation upon an input structure.

It is yet a further object of the present invention to propose the method of “one-actuation” based on a dedicated input structure of the mobile device or of a remote control device.

In an exemplary implementation, the digital television system and the mobile device may be connectable through an ad hoc communication link such as a Bluetooth type of connection. The digital television system and the mobile device may also be connected to a communication network. Digital media contents such as digital video programs may be delivered to the devices through the communication network.

According to one embodiment, a video program is streamed by the mobile device. After an input structure of the mobile device is actuated by the user, a data file including metadata of the video program and the status of the program is sent from the mobile device to the digital television system. The status of the program may include the time and the portion of video program being played. Upon receiving the data file, the digital content of the program is delivered from a content distributor to the digital television system. The program is streamed by the television system according to the same schedule as the mobile device's.

According to another embodiment, a video program is streamed by the digital television system. A data file including metadata and the status of the program is sent from the digital television system to the mobile device after the user actuates the input structure of the mobile device. Upon receiving the data file, the digital content of the program is delivered from a content distributor to the mobile device. The program is streamed by the mobile device according to the same schedule as that of the digital television system.

According to one implementation, the input structure may be a dedicated one of the mobile device including a button, a switch and a touchpad. According to another implementation, the input structure may be an icon or an image displayed on a touch-sensitive screen. The user may use one of the fingers to make the selection to trigger the operation of the synchronization.

According to another implementation, the input structure may be with a remote control device of the digital television system.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a media asset delivery system based on a digital TV system and a mobile communication device in accordance with one embodiment;

FIG. 2A is a schematic diagram of functional blocks and data flows of the system in accordance with embodiment A;

FIG. 2B is a schematic diagram of functional blocks and data flows of the system in accordance with embodiment B;

FIG. 2C is a schematic diagram of functional blocks and data flows of the system in accordance with embodiment C;

FIG. 2D is a schematic diagram of functional blocks and data flows of the system in accordance with embodiment D;

FIG. 3 is a schematic diagram illustrating exemplarily a dedicated button of a mobile device is used to control the operation of synchronization;

FIG. 4A is a schematic diagram of functional blocks of the digital TV system in accordance with one implementation;

FIG. 4B is a schematic diagram of functional blocks of the mobile communication device in accordance with one implementation;

FIG. 5 is a flowchart illustrating an exemplary process that the digital television system is synchronized to the mobile device for streaming a video program;

FIG. 6 is a flowchart illustrating an exemplary process that the mobile device is synchronized to the digital television system for streaming a video program.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

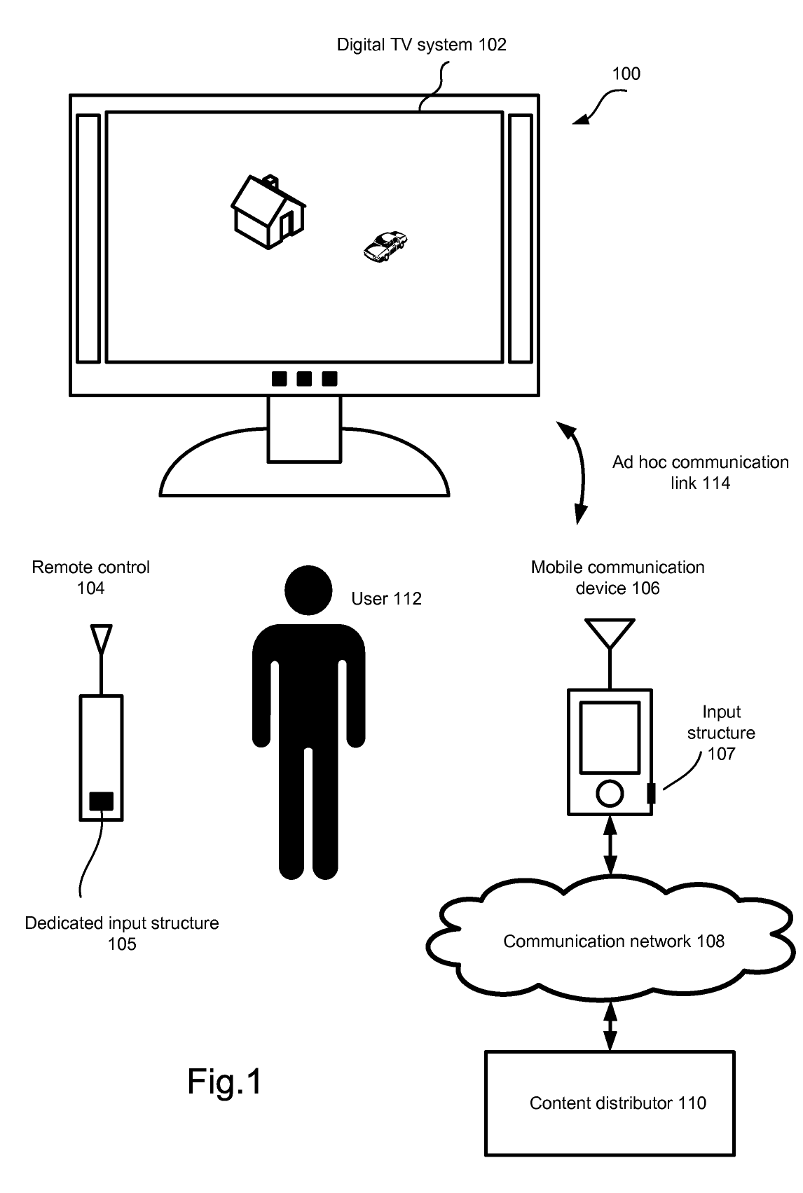

FIG. 1 is a schematic diagram illustrating a media delivery system according to one embodiment. The system 100 comprises a digital TV system 102 with a remote control device 104. According to one implementation, the remote control device 104 may include a dedicated input structure 105 for controlling of synchronization of streaming a video program between the digital TV system 102 and a mobile computing and communication device 106. The input structure 105 may be a button, a switch and a touch pad. The input structure 105 may also be an icon in a touch-sensitive display. According to another implementation, the mobile device 106 may include an input structure 107 for controlling synchronization of the digital TV system and the mobile device. It should be noted that one of the input structures 105 or 107 is sufficient for the operation of the system.

The mobile communication device 106 may be a mobile phone with the Internet connection capability. The mobile device 106 is connectable to a content distributor 110 through a communication network 108. The digital TV system 102 may also be connected to the content distributor 110 through the communication network 108 (not shown in FIG. 1). A user 112 operates the system. The remote control device 104 and the digital TV system 102 are connected employing one of well known methods such as, for example, using the Infrared communication interface. The digital TV system 102 and the mobile device 106 may be connected using an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

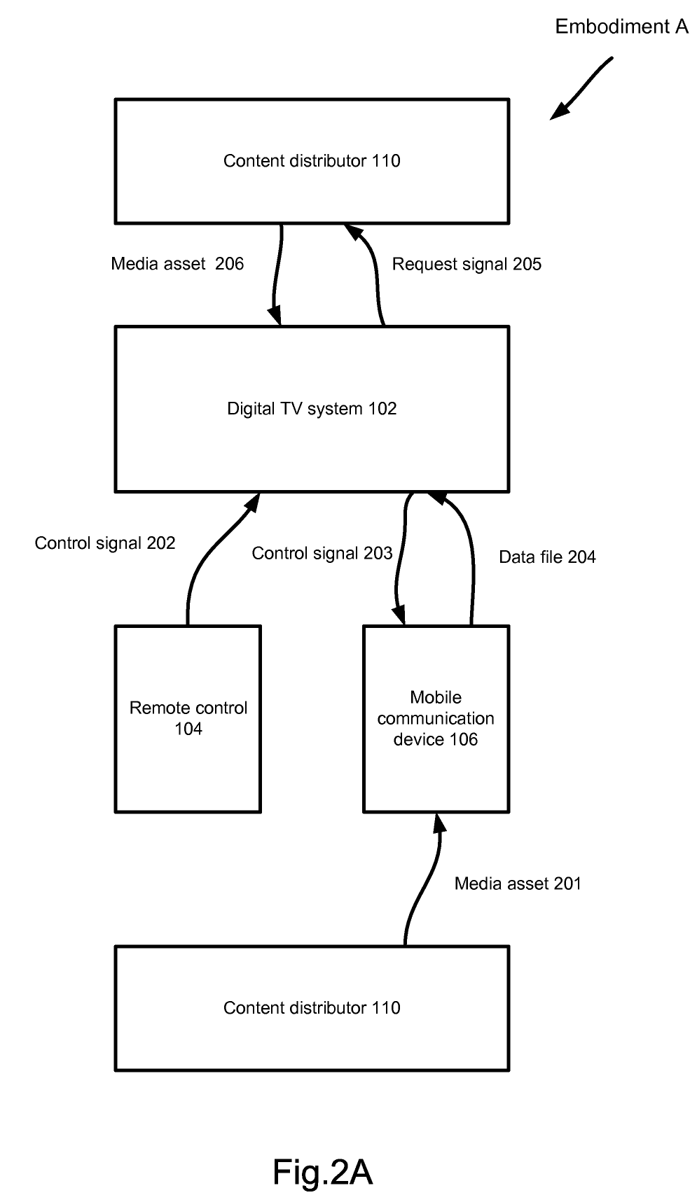

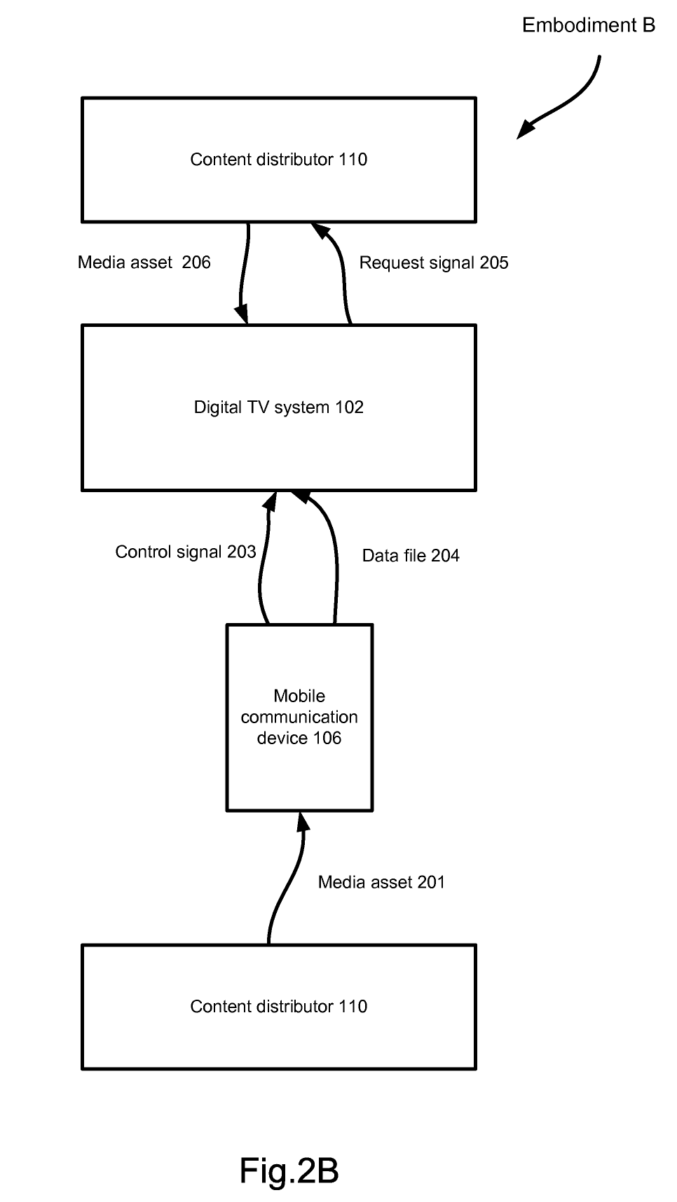

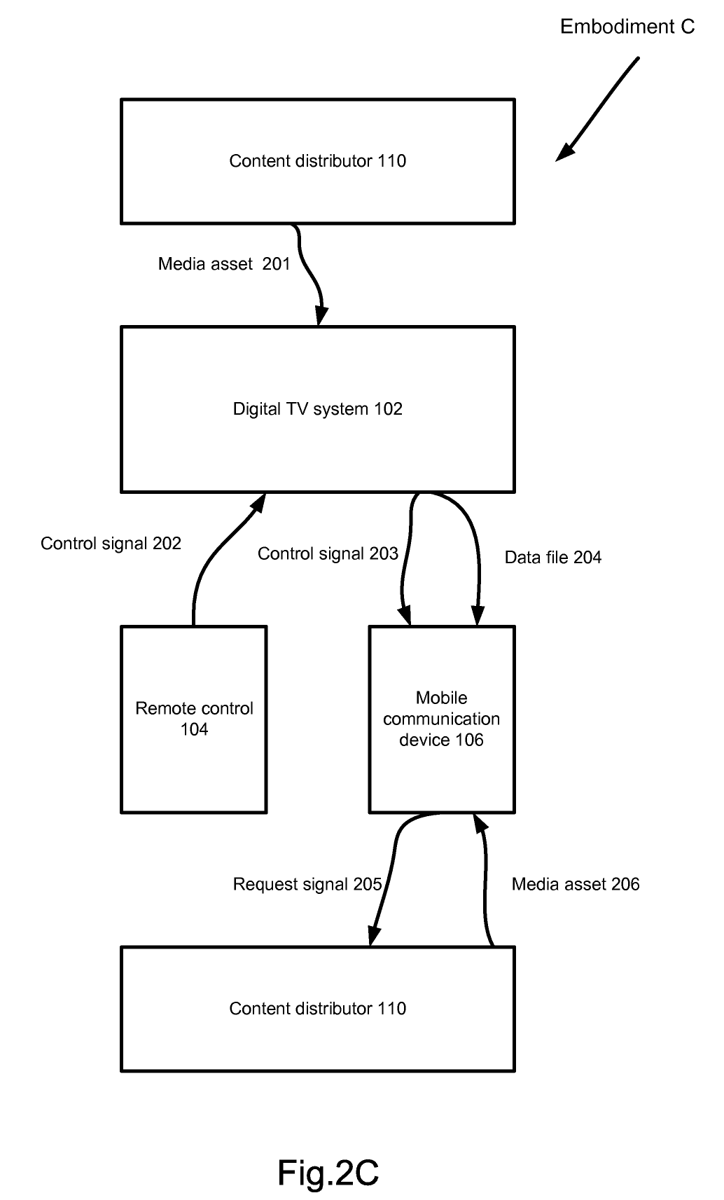

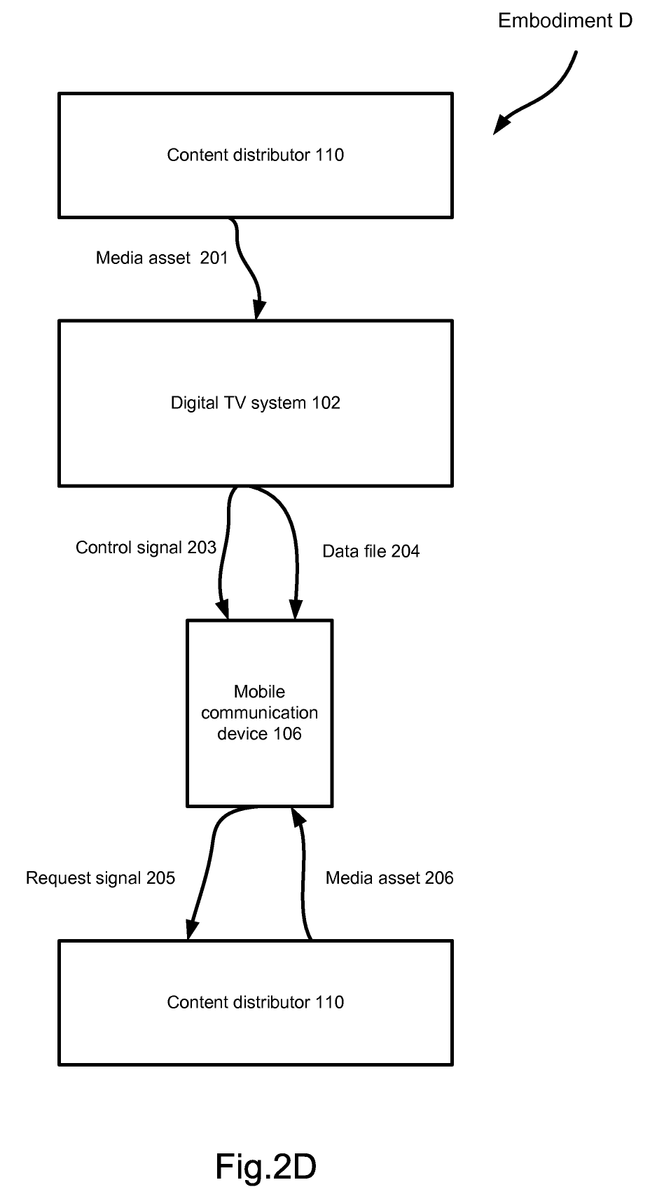

FIG. 2A is a schematic diagram of functional blocks and data flows of the system 100 in accordance with the embodiment A. When the mobile device 106 is used to stream a video program 201 (media asset) received from the content distributor 110, a control signal 202 is sent from the remote control device 104 to the digital TV system 102 after the user actuates the remote control device 104. Upon receiving the control signal 202, the digital TV system 102 sends another control signal 203 to the mobile device 106. A data file 204 including metadata and the status of the program is sent from the mobile device 106 to the digital TV system 102. After the data file 204 is received by the digital TV system 102, the digital TV system sends a request signal 205 to the content distributor 110. The content distributor 110 sends the video program 206 (media asset) to the digital TV system 102. 206 and 201 may the same media asset. 206 may be a portion of 201. The user may need to pay for 201 and 206. The user may only need to pay for 201.

It should be noted that the video program 201 and 206 may be the same content by different formats. For example, the video program 201 for the mobile device 106 may be a compressed version of the video program 206 for the digital TV system 102.

Upon receiving the media asset 206, the digital TV system 102 starts to stream the program based on the time and the status data in the data file 204.

FIG. 2B is a schematic diagram of functional blocks and data flows of the system 100 in accordance with the embodiment B. When the mobile device 106 is used to stream a video program 201 received from the content distributor 110, a control signal 202 is sent from the mobile device 106 to the digital TV system 102 after the user actuates an input structure of the mobile device. A data file 204 including metadata and the status of the program is subsequently sent from the mobile device 106 to the digital TV system 102. After the data file 204 is received by the digital TV system 102, the digital TV system 102 sends a request signal 205 to the content distributor 110. The content distributor 110 sends the video program 206 to the digital TV system 102. The video program may be only a portion of the digital content being streamed by the mobile device 106. Upon receiving the video program 206, the digital TV system 102 starts to stream the program based on the time and the status data included in the data file 204.

FIG. 2C is a schematic diagram of functional blocks and data flows of the system 100 in accordance with the embodiment C. When the digital TV system 102 is used to stream a video program 201 received from the content distributor 110, a control signal 202 is sent from the remote control device 104 to the digital TV system 102 after the user actuates the remote control device 104. Upon receiving the control signal 202, the digital TV system 102 sends another control signal 203 to the mobile device 106. A data file 204 including metadata and the status of the program is sent from the digital TV system 102 to the mobile device 106. After the data file 204 is received by the mobile device 106, the device sends a request signal 205 to the content distributor 110. The content distributor 110 sends the video program 206 to the mobile communication device 106. The media asset may be only a portion of the digital content being streamed by the digital TV system 102. Upon receiving 206, the mobile device 106 starts to stream the program based on the time and the status data included in the data file 204.

FIG. 2D is a schematic diagram of functional blocks and data flows of the system 100 in accordance with the embodiment D. When the digital TV system 102 is used to stream a video program 201 received from the content distributor 110, a control signal 203 is sent from the digital TV system 102 to the mobile device 106 after the user actuates an input structure of the mobile device 106. Upon receiving the control signal 203, the digital TV system 102 sends a data file 204 including metadata and the status of the program from the digital TV system 102 to the mobile device 106. After the data file 204 is received by the mobile device 106, the device sends a request signal 205 to the content distributor 110. The content distributor 110 sends the video program 206 to the mobile device 106. The video program 206 may be only a portion of the digital content being streamed by the mobile device 106. Upon receiving the media asset 206, the mobile device 106 starts to stream the program based on the time and the status data included the data file 204.

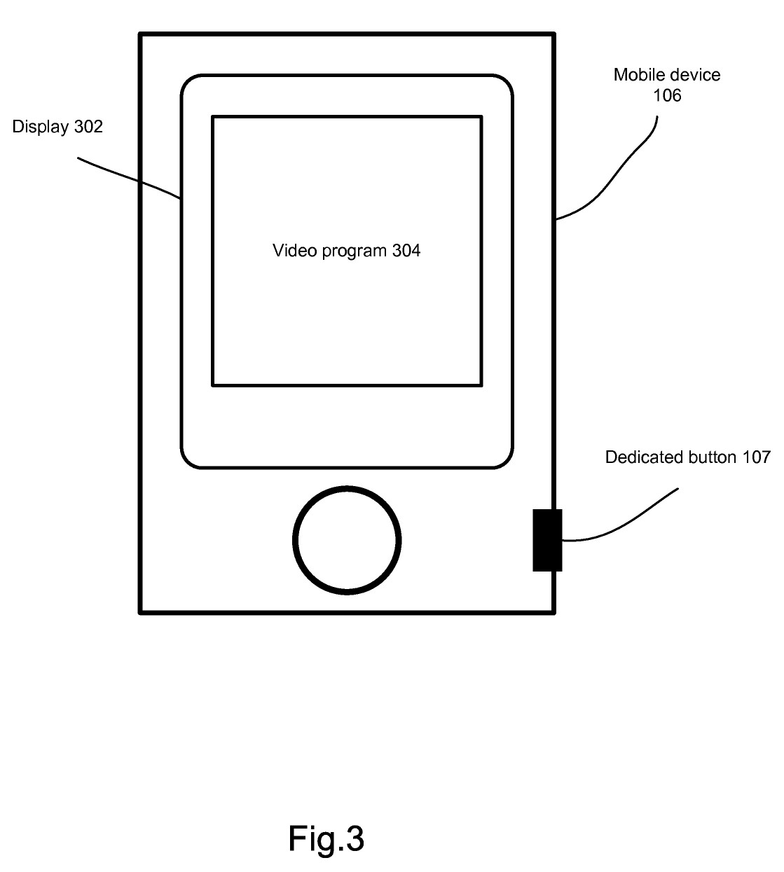

FIG. 3 is a schematic diagram illustrating a dedicated button 107 of a mobile device 106 is used to control the operation of synchronization. According to one implementation of the present invention, the mobile device is a smart phone including a display 302. The mobile device 106 may be connected to a communication network such as the Internet. A video program 304 may be broadcasted on the display 302. The video program 304 may be received from a content distributor 110 through the communication network.

The mobile device 106 may also be a portable media player, a portable game console, a tablet compute, a laptop computer and a PDA.

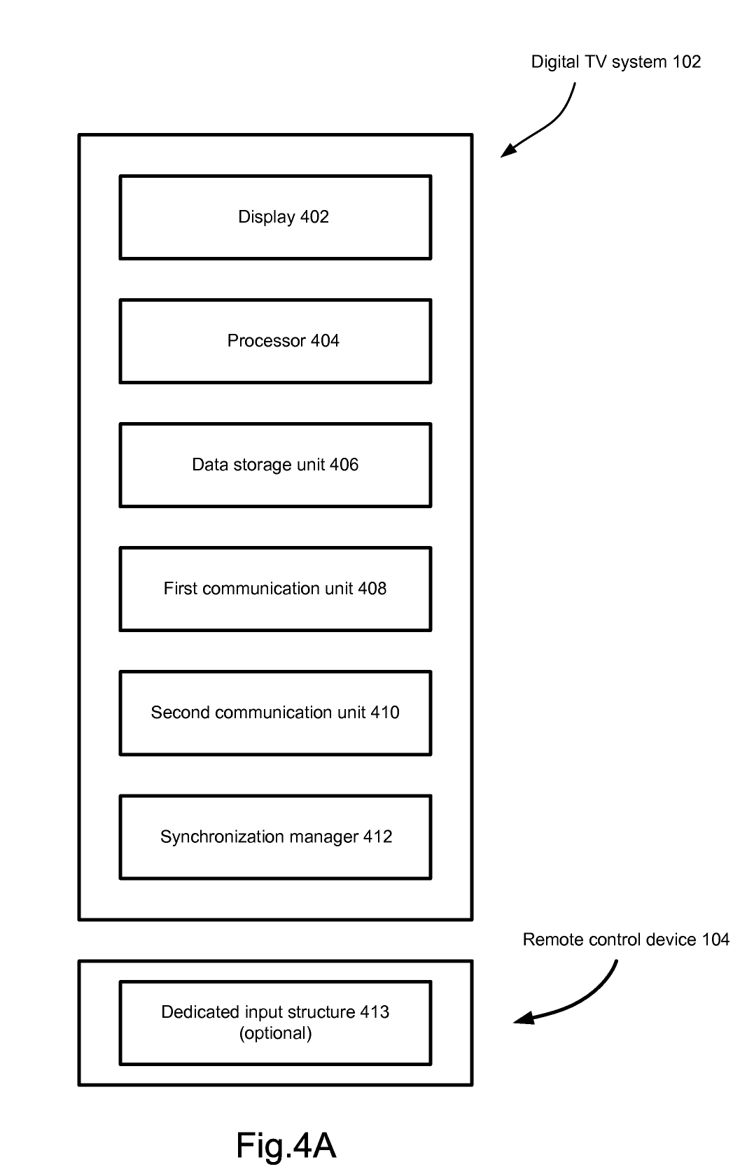

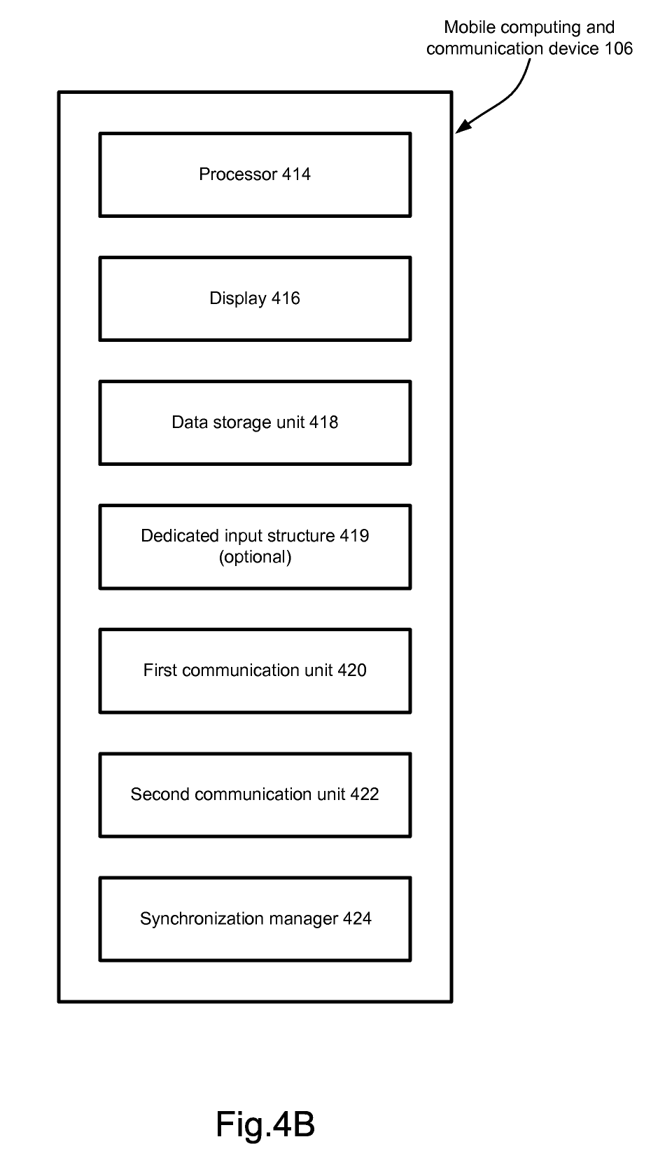

FIG. 4A is a schematic representation of functional blocks of the digital TV system 102 in according with one embodiment. The system 102 comprises a display 402. The display may be a Liquid Crystal Display (LCD). The display may also be any other types of display as known in the art. A processor 404 is used to control the operation of the digital TV system 102. The processor 404 may include more than one type of processors including a general purpose processor such as a Central Processing Unit (CPU) and a special purpose processor such as a Graphical Processing Unit (GPU). The system 102 may also include a data storage unit 406 such as a magnetic storage unit and/or semiconductor memory devices.

The digital TV system 102 may be connected to a communication network through a first communication unit 408. The network may be a private broadband network for delivering TV programs. The network may also be a public network such as, for example, the Internet. A second communication unit 410 is used to connect the digital TV system 102 to the mobile device 106 through an ad hoc communication link 114. The ad hoc communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). The digital TV system 102 may also include a third communication unit (not shown in the figure) for connecting the system and the remote control device 104. Most remote control devices today use Infrared communication interfaces.

A synchronization manager 412 is used to synchronize the digital TV system 102 and the mobile device 106. The synchronization manager 412 may be implemented as software. The synchronization ion manager 412 may also be implemented as a combination of the software and the hardware.

The remote control device 104 may include a dedicated input structure 413 for controlling the synchronization. The input structure 413 may be a button, a switch and a touchpad.

FIG. 4B is a schematic representation of functional blocks of the mobile communication device 106. The device 106 comprises a processor 414, a display 416 and a data storage unit 418. The display 416 may be a touch-sensitive type of display. The mobile device 106 may include a dedicated input structure 419, in addition to conventional input unit of the device, for “one-actuation”control of the synchronization. The mobile device 106 includes a first communication unit 420. The first communication unit 420 may be a standard network interface for a smart phone including a capability to connect to the Internet. The device 106 further comprises a second communication unit 422 for connecting to the digital TV system 102 through the previously mentioned ad hoc communication link 114. The communication unit 422 in the mobile device 106 and the communication unit 410 in the digital TV system 102 may conform to the same communication standard.

A synchronization manager 424 is used to synchronize the digital TV system 102 and the mobile device 106. The synchronization manager 412 may be implemented as software. The synchronization ion manager 412 may also be implemented as a combination of the software and the hardware.

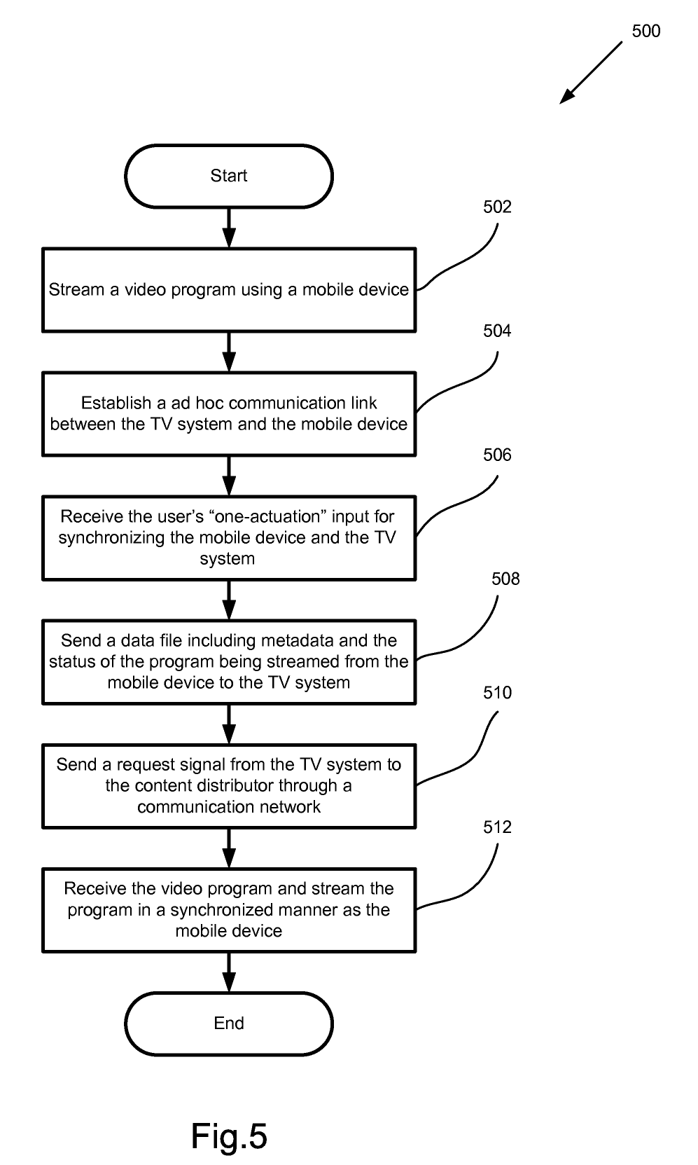

FIG. 5 is a flowchart illustrating an exemplary process that the digital television system is synchronized to the mobile device for broadcasting a video program. Process 500 starts with step 502 that a video program is viewed by a user using the mobile device 106. The mobile device may be a smart phone according to one implementation. The video program may be sent from the content distributor 110 through a communication network 108. An ad hoc communication link 114 is established in step 504 between the digital TV system 102 and the mobile device 106. In step 506, the user's “one-actuation” input is received for synchronizing the digital TV system 102 and the mobile device 106. According to one embodiment of the present invention, the user actuates an input structure of the remote control device 104. According to another embodiment, the user actuates an input structure of the mobile device 106. In step 508, a data file 204 including metadata of the program being streamed and the status of the program is sent from the mobile device 106 to the digital TV system 102. A request signal, in step 510, is then sent from the digital TV system 102 to the content distributor 110 through the communication network 108. The user may need to pay for the request. The content distributor 110 sends the digital content of the program to the digital TV system 102. The digital content may be only the portion of the content unfinished in the mobile device 106. The digital content may employ a high definition format while the one used by the mobile device 106 may be a compressed version of the digital content. In step 512, the received digital content is streamed in a synchronized manner as the mobile device 106 based on the received data file 204.

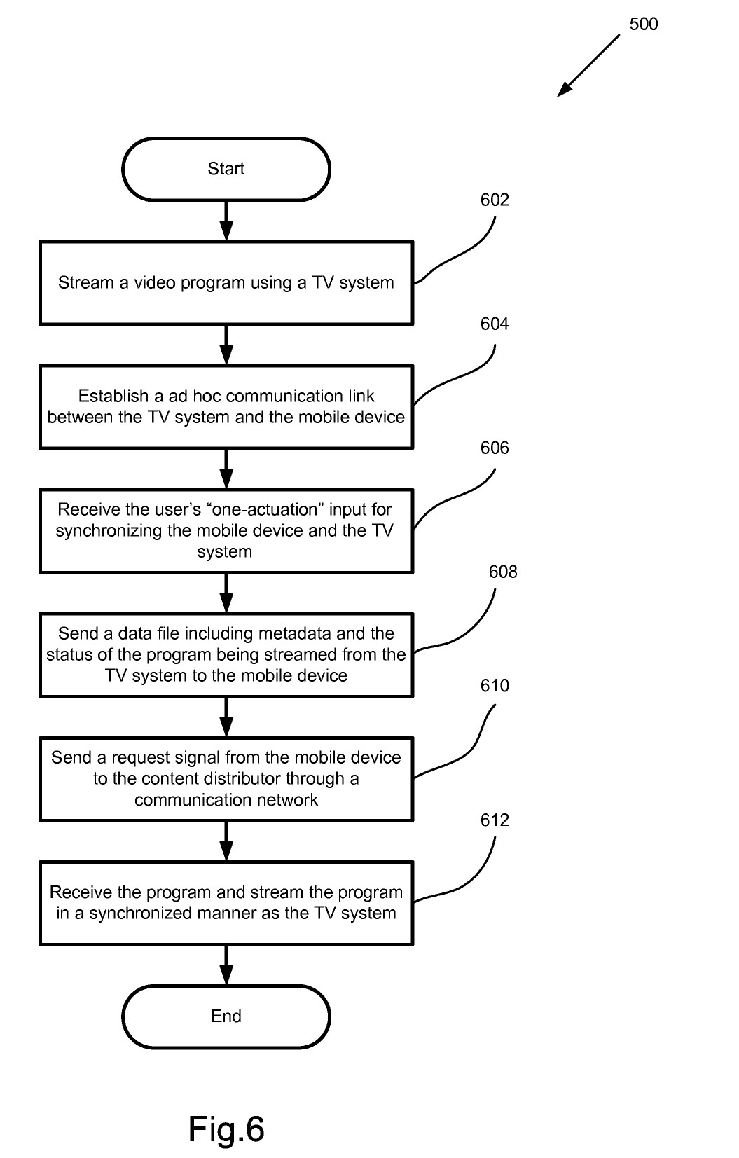

FIG. 6 is a flowchart illustrating an exemplary process that the mobile device 106 is synchronized to the digital television system 102 for streaming a video program. Process 600 starts with step 602 that a video program is viewed by a user using the digital TV system 102. The video program may be sent from a content distributor 110 through a communication network 108. The video program may employ a high definition format. An ad hoc communication link 114 is established in step 604 between the digital TV system 102 and the mobile device 106. In step 606, the user's “one-actuation” input is received for synchronizing the digital TV system 102 and the mobile device 106. According to one embodiment of the present invention, the user actuates an input structure of the remote control device 104. According to another embodiment, the user actuates an input structure of the mobile device 106. In step 608, a data file 204 including metadata of the program being streamed by the digital TV system 102 and the status of the program is sent from the digital TV system 102 to the mobile device 106. A request signal, in step 610, is then sent from the mobile device 106 to the content distributor 110 through the communication network 108. The user may need to pay for the request. The content distributor 110 sends the digital content of the program to the mobile device 106. The content may be only the unfinished portion in the digital TV system 102. The content may also be a compressed version for the mobile device. In step 612, the received digital content is streamed in a synchronized manner as the digital TV system 102 based on the received data file 204.

1. A media delivery system comprising:
a digital television system including a remote control device;
a mobile computing and communication device; and
a communication link for connecting the digital television system and the mobile device; and
a means of controlling synchronization of streaming a video program by the digital television system and by the mobile device,
wherein said means of controlling synchronization further comprising:
actuating an input structure;
transmitting a data file including metadata and status of the program being streamed by the mobile device to the digital television system and starting to stream the program in the digital television system based on received data file; or
transmitting a data file including metadata and status of the program being streamed by the digital television system to the mobile device and starting to stream the program in the mobile device based on the received data file.

2. The system as recited in claim 1, wherein said digital television system further comprising:
a display screen;
a processor;
a data storage unit;
a first communication unit for connecting to a communication network;
a second communication unit for connecting to the mobile device; and
a synchronization manager.

3. The system as recited in claim 1, wherein said mobile device further comprising:
a processor;
a display;
a data storage unit;
a first communication unit for connecting to a public communication network;
a second communication unit for connecting to the digital television system; and
a synchronization manager.

4. The system as recited in claim 1, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

5. The system as recited in claim 1, wherein said input structure may be a dedicated structure of the mobile device including a button, a switch and a touchpad.

6. The system as recited in claim 1, wherein said input structure may be an icon displayed on a screen of the mobile device.

7. The system as recited in claim 1, wherein said input structure may be a dedicated structure of the remote control device including a button, a switch and a touchpad.

8. The system as recited in claim 1, wherein said input structure may be an icon displayed on a screen of the remote control device.

9. The system as recited in claim 1, wherein said mobile device may be based on a device selected from the following group:
a mobile phone;
a portable media player;
a tablet computer;
a laptop computer;
a Personal Digital Assistant (PDA); and
a game console.

10. The system as recited in claim 1, wherein said video program may be delivered from a content distributor to the mobile device and to the digital television system through a communication network, wherein the program streamed by the mobile device and by the digital television system may be in a different format, wherein the program streamed by the mobile device may be a compressed version.

11. A method for controlling of synchronization of a digital television system and a mobile computing and communication device connected through a communication link for streaming a video program, the method comprising:
actuating an input structure of the mobile device or a remote control device;
transmitting a data file including metadata and status of the program being streamed by the mobile device to the digital television system and starting to stream the program in the digital television system based on received data file; or
transmitting a data file metadata and status of the program being streamed by the digital television system to the mobile device and starting to stream the program in the mobile device based on the received data file.

12. The method as recited in claim 11, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

13. The method as recited in claim 11, wherein said method further including a step of delivering the program from a content distributor to the digital television system or to the mobile device through a communication network including the Internet.

14. The method as recited in claim 11, wherein said input structure may be a dedicated structure of the mobile device including a button, a switch and a touchpad.

15. The method as recited in claim 11, wherein said input structure may be an icon displayed on a screen of the mobile device.

16. The method as recited in claim 11, wherein said input structure may be a dedicated structure of the remote control device including a button, a switch and a touchpad.

17. A mobile computing and communication device comprising:
a processor;
a display;
a data storage unit;
a first communication unit for connecting to a public communication network;
a second communication unit for connecting to a digital television system;
an input unit; and
a synchronization manager for synchronizing of streaming a video program between the mobile device and the digital television system.

18. The device as recited in claim 17, wherein said second communication unit conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

19. The device as recited in claim 17, wherein said synchronization manager further comprising a means of transmitting metadata of the program and the status of the program from the mobile device to the digital television system or vice versa.

20. The device as recited in claim 17, wherein said input unit further comprising a dedicated input structure for triggering of synchronizing the mobile device and the digital television system upon an actuation by a user.
